(19) United States
(12) Patent Application Publication
(10) Pub. No.: US 2018/0307068 A1
(43) Pub. Date: Oct. 25, 2018

(54) PDLC DISPLAY PANEL, PDLC DISPLAY DEVICE AND DRIVING METHOD THEREOF

(71) Applicant: BOE TECHNOLOGY GROUP CO., LTD., Beijing (CN)

(72) Inventor: Pengxia LIANG, Beijing (CN)

(21) Appl. No.: 15/569,795

(22) PCT Filed: Mar. 29, 2017
(86) PCT No.: PCT/CN17/78566

§ 371 Date: Oct. 27, 2017

(30) Foreign Application Priority Data
Aug. 8, 2016 (CN) 201610640971.1

(51) Int. Cl. G02F 1/1334; G02F 1/1343; G02F 1/135; G02F 1/1362; G02F 1/1335

(52) U.S. Cl. CPC G02F 1/1334; G02F 1/134309; G02F 1/1354; G02F 2202/10; G02F 1/133617; G02F 2001/134345; G02F 1/136286

(57) ABSTRACT

A PDLC display panel, includes a first transparent substrate; a second transparent substrate arranged opposite to the first transparent substrate; a first electrode layer arranged on a side of the first transparent substrate close to the second transparent substrate; a second electrode layer arranged on a side of the second transparent substrate close to the first transparent substrate, the second electrode layer comprising a plurality of second sub-electrodes arranged in an array; a PDLC layer arranged between the first electrode layer and the second electrode layer; and a photochromic layer arranged on a side of the second transparent substrate remote from the PDLC layer for achieving color display. A PDLC display device including the PDLC display panel and a driving method thereof is further disclosed.

### RELATED APPLICATIONS

The present application is the U.S. national phase entry of PCT/CN2017/078566, with an international filling date of Mar. 29, 2017, which claims the priority of the Chinese patent application No. 201610640971.1 filed on Aug. 8, 2016, the disclosures of which are incorporated herein by reference.

### TECHNICAL FIELD

The present disclosure relates to the field of display technologies, and specifically relates to a polymer dispersed liquid crystal (PDLC) display panel, a PDLC display device and a driving method thereof, which are in particular applied for transparent display and color display.

### BACKGROUND

Generally, a liquid crystal display device achieves display of images by using optical anisotropy and birefringence of liquid crystal molecules. This usually requires arrangements of polarizers, alignment layers, and so on. However, these polarizers or alignment layers often give rise to serious optical damage or occlusion.

To this end, PDLC display devices have been proposed. PDLCs are formed by mixing small molecule liquid crystals with a prepolymer to form micron-scale liquid crystal microdroplets through polymerization under certain conditions and disperse them uniformly in a polymer grid. Electro-optical response characteristics are realized in PDLCs by means of dielectric anisotropy of liquid crystal molecules. PDLCs mainly operate between a light scattering state and a transparent state, and are generally divided into two types: forward PDLCs and inverse PDLCs. For a forward PDLC, it exhibits a light scattering state when energized and a transparent state when non-energized. For an inverse PDLC, oppositely, it exhibits a transparent state when energized and a light scattering state when non-energized. Since a PDLC display device does not require arrangements of polarizers, alignment layers, and so on, the manufacture becomes easier and the light utilization is higher. Thus, it has attracted more and more attention and found wide application in various fields.

At present, devices for achieving transparent and color display by using PDLCs have been proposed. According to a specific implementation, a PDLC layer is filled with color dyes. However, in such an implementation, it is difficult to form PDLCs of three colors R, G and B as sub-pixels simultaneously and arrange them in a same pixel layer. Therefore, only monochromatic PDLCs can be obtained. According to another specific implementation, two or more PDLC layers are used to achieve color display. However, for the latter case, the display device comprises two or even more PDLC layers. This potentially decreases the light utilization, and affects the transparent display effect of the display device to a certain degree.

### SUMMARY

Based on the above discussion, embodiments of the present disclosure provide a PDLC display panel, a PDLC display device and a driving method thereof, so as to at least partially alleviate or eliminate one or more of the defects pointed out above.

According to one aspect of the present disclosure, a PDLC display panel is provided. The PDLC display panel comprises: a first transparent substrate; a second transparent substrate arranged opposite to the first transparent substrate; a first electrode layer arranged on a side of the first transparent substrate close to the second transparent substrate; a second electrode layer arranged on a side of the second transparent substrate close to the first transparent substrate, the second electrode layer comprising a plurality of second sub-electrodes arranged in an array; a PDLC layer arranged between the first electrode layer and the second electrode layer; and a photochromic layer arranged on a side of the second transparent substrate remote from the PDLC layer for achieving color display.

In a specific embodiment of the PDLC display panel according to the present disclosure, the PDLC display panel further comprises a plurality of pixel units defined by intersections of gate lines and data lines, each pixel unit comprising a second sub-electrode. According to another specific embodiment, the photochromic layer comprises a plurality of regions, and each region corresponds to at least three adjacent pixel units in the plurality of pixel units.

Furthermore, each region of the photochromic layer corresponds to three adjacent pixel units in the plurality of pixel units. Each region of the photochromic layer comprises a first sub-region, a second sub-region and a third sub-region corresponding respectively to the corresponding three adjacent pixel units. Besides, the first sub-region comprises a first material that turns red under a photochromic reaction, the second sub-region comprises a second material that turns green under a photochromic reaction, and the third sub-region comprises a third material that turns blue under a photochromic reaction. Similar to the arrangement in a conventional RGB color film substrate, in the present disclosure, the photochromic layer comprises a plurality of regions, each region comprising a first sub-region (i.e., R sub-region), a second sub-region (i.e., G sub-region) and a third sub-region (i.e., B sub-region) respectively. With such regions and RGB arrangement, the R, G and B sub-regions will become red, green and blue respectively, after a photochromic reaction. Color display of different gray levels in each region of the photochromic layer is achieved, in further combination with the characteristic that different intensities of light induce the photochromic reaction, which will be discussed below in detail.

In a specific embodiment of the PDLC display panel according to the present disclosure, the first material, the second material and the third material in each region of the photochromic layer comprise respectively one selected from: a material of semiconductor oxides, a composite material of polyacids and semiconductors, and a composite material of heteropoly metal compounds and inorganic semiconductors. Obviously, a skilled person in the art can appropriately choose any other suitable photochromic material upon actual needs, which is not only limited to those listed above.

In a specific embodiment of the PDLC display panel according to the present disclosure, material suitable for the first electrode layer comprise indium tin oxide (ITO) or indium zinc oxide (IZO). Similarly, materials suitable for the second electrode layer comprise indium tin oxide (ITO) or indium zinc oxide (IZO). Furthermore, the first transparent substrate comprises a transparent glass substrate or a transparent plastic substrate.

Likewise, the second transparent substrate comprises a transparent glass substrate or a transparent plastic substrate.

Obviously, as can be understood by a skilled person in the art, the materials listed above are only examples of specific materials for forming the photochromic layer, the first and/or second electrode, and the first and/or second transparent substrate, and the present disclosure is not only limited thereto. Benefiting from teachings of the present disclosure, the skilled person can easily obtain other equivalent alternative materials.

In a specific embodiment of the PDLC display panel according to the present disclosure, the first transparent substrate and the second transparent substrate comprise a flexible film, and the first electrode layer and the second electrode layer comprise a flexible conductive film. According to such a specific embodiment, the first/second transparent substrate and the first/second electrode layer can be both made as flexible. Moreover, the PDLC layer and the photochromic layer as solid materials can be directly arranged on such a flexible film layer, thereby obtaining a flexible PDLC display panel.

In a specific embodiment of the PDLC display panel according to the present disclosure, the PDLC layer is configured to exhibit a light scattering state when energized and a transparent state when non-energized.

Alternatively, the PDLC layer is configured to exhibit a transparent state when energized and a light scattering state when non-energized. No matter which way is taken, the PDLC layer can make transitions between a transparent state and a light scattering state.

According to another aspect of the present disclosure, a PDLC display device is provided. The PDLC display device comprises: the PDLC display panel as described in any of the above embodiments; and a light source, wherein light emitted from the light source causes a photochromic reaction in the photochromic layer after passing through the PDLC layer.

In a specific embodiment of the PDLC display device according to the present disclosure, the PDLC display device further comprises: a light guide plate arranged on a side of the first transparent substrate remote from the first electrode layer, and the light source is arranged at a light incident side of the light guide plate, in particular on a side surface of the light guide plate. In a specific embodiment, the light guide plate is chosen as a transparent light guide plate. By arranging the light source on a side surface of the display device body, possible optical losses, such as occlusion and absorption caused by non-transparent light sources, can be avoided. Thus, the light utilization of the entire display device is further improved, and the transparent and color display effects are enhanced. Besides, by means of such a light guide plate, light emitted from the light source can be more conveniently transmitted through the PDLC layer and then incident on the photochromic layer afterwards.

In a specific embodiment of the PDLC display device according to the present disclosure, the light source is configured to emit light in a UV region or a visible region. Light emission of different colors as required by the display can be obtained, after the photochromic reaction by virtue of different photochromic responses of the photochromic layer to UV light or visible light.

In a specific embodiment of the PDLC display device according to the present disclosure, the PDLC display device further comprises: a reset light source configured to discolor the photochromic layer after the photochromic reaction and restore it to its initial state. As described above in detail, the photochromic layer will be subjected to a photochromic reaction when induced by corresponding light, and thereby emit light of a color different from that in the initial state. Besides, such a photochromic reaction of the photochromic layer is caused by changes in the molecular structures. Therefore, after the photochromic reaction, even if light from the light source is cut out, the photochromic layer will maintain in a new state after the color change, instead of resuming the initial state before the color change. Based on this point, stable display can be achieved. In other words, a photochromic reaction is firstly induced by light, then the light is cut out, and the PDLC display device is non-energized (i.e., the PDLC layer is in a transparent state). After that, since the photochromic layer maintains in that state after the color change, it will continuously display patterns (like in the case where the PDLC display device is energized and light of the light source is applied). On the other hand, if other patterns or patterns of a next frame need to be displayed, it is only necessary to simply apply a reset light source, so as to discolor the photochromic layer and restore it to the initial state.

According to yet another aspect of the present disclosure, a method for driving the PDLC display device according to any of the above embodiments is provided. The driving method comprises: applying a constant first voltage to the first electrode layer, and applying different second voltages to the second sub-electrodes of the plurality of pixel units respectively, such that different portions of the PDLC layer exhibit different light scattering states; and passing light emitted from the light source through the PDLC layer exhibiting a light scattering state and irradiating the photochromic layer to cause a photochromic reaction, thereby achieving display. Through the above driving process, the PDLC layer exhibits a light scattering state, and different degrees of light scattering are exhibited due to different voltages applied at different pixel units. In other words, different degrees of light scattering in different portions of the PDLC layer can be achieved by controlling the voltages applied to the first electrode layer and the second sub-electrodes. This also means that the light irradiating different portions of the photochromic layer will have different intensities. This induces different degrees of photochromic reaction, and further achieves display of different gray levels. In this way, patterning of the PDLC layer and also normal display functions are achieved.

According to a specific embodiment of the present disclosure, the method for driving the PDLC display device further comprises: shutting down the light source and cutting off the voltages applied to the first electrode layer and the second sub-electrodes, such that the PDLC layer exhibits a transparent state. In this case, the PDLC display device exhibits a transparent state. Due to the photochromic reaction that has taken place previously, the photochromic layer will maintain in the state after color change. I.e., different portions are subjected to different degrees of photochromic reaction because of excitations by light of different intensities. Therefore, the PDLC display device will continuously display patterns like in the case where it is energized and light of the light source is applied, thereby achieving stable display.

According to a specific embodiment of the present disclosure, the method for driving the PDLC display device further comprises: emitting reset light by the reset light source to the photochromic layer, so as to discolor the photochromic layer after the photochromic reaction and restore it to its initial state. With such a reset light source, display of other patterns or patterns of a next frame is facilitated.

As can be seen, in the PDLC display panel, the PDLC display device and the driving method thereof as disclosed in the embodiments of the present disclosure, a photochromic layer is arranged, in addition to the PDLC layer sandwiched between two electrodes. With excitation by suitable light, such a photochromic layer can be subjected to a photochromic reaction, and thus emit light of a color different from that in the initial state. In this case, assuming that a forward PDLC layer is adopted, i.e., the PDLC layer exhibits a light scattering state when energized and a transparent state when non-energized. If no voltage is applied to the PDLC layer, each component (i.e., each layer) in the PDLC display device will exhibit a transparent state, thus obtaining transparent display. On the other hand, if a voltage is applied to the PDLC layer, i.e., the PDLC layer exhibits light scattering characteristics, by controlling different voltage values applied to the PDLC layer, light incident on the photochromic layer will have different intensities, which induces different degrees of photochromic reaction. After that, by virtue of the fact that the photochromic layer emits light of different intensities after the photochromic reaction, display of different gray levels for various colors is achieved. As can be seen, according to embodiments of the present disclosure, both transparent display and various color displays of different gray levels can be achieved. In addition, in the PDLC display panel according to embodiments of the present disclosure, on one hand, only one PDLC layer is comprised, and on the other hand, no polarizers or alignment layers are required. As a result, the light loss (for example caused by absorption, occlusion, and so on) is greatly decreased. Also, the light utilization is improved, and the display effect is enhanced significantly.

Besides, according to embodiments of the present disclosure, the PDLC display panel and the PDLC display device are not only helpful in achieving transparent and color display of higher efficiency and higher quality, but also compatible with any existing TFT-LCF process due to their simple structures. Moreover, such a PDLC display panel and device can be designed as flexible products for achieving flexible transparent display. Furthermore, stable display and easy substitutability of the photochromic layer are also taken into consideration, and implementations of more flexible and more energy-saving PDLC display panel and devices are facilitated as well.

### BRIEF DESCRIPTION OF DRAWINGS

FIGS. 1A-1B show schematic distribution views of liquid crystal molecules in a PDLC layer of a PDLC display panel according to an embodiment of the present disclosure when no voltage is applied and when a voltage is applied respectively;

FIG. 2 shows an exemplary section view of a PDLC display panel according to an embodiment of the present disclosure;

FIG. 3 shows a top view of a photochromic layer in a PDLC display panel according to an embodiment of the present disclosure;

FIG. 4 shows a top view of a photochromic layer in a PDLC display panel and an enlarged top view of a region therein according to an embodiment of the present disclosure;

FIG. 5 shows a schematic section view of a PDLC display device according to an embodiment of the present disclosure; and

FIG. 6 shows a schematic flow diagram of a method for driving a PDLC display device according to an embodiment of the present disclosure.

### DETAILED DESCRIPTION OF EMBODIMENTS

Detailed description of one or more embodiments of the present disclosure will be provided below, together with the drawings showing principles of the present disclosure. The present disclosure is described in combination with these embodiments, but it is not limited to any of them. The scope of the present disclosure is only limited by the claims, and the present disclosure covers numerous substitutable solutions, modifications, and equivalent solutions. Many specific details will be illustrated in the description below so as to provide a thorough understanding of the present disclosure. These details are only provided for exemplary purposes, and the present disclosure can be carried out according to claims without some or all of the specific details. For the purpose of clarity, technical materials known in the technical field related to the present disclosure have not been described in detail, so as not to obscure the present disclosure with unnecessary details.

The PDLC display panel, the PDLC display device, and the driving method thereof disclosed in embodiments of the present disclosure will be described below in detail with reference to the drawings.

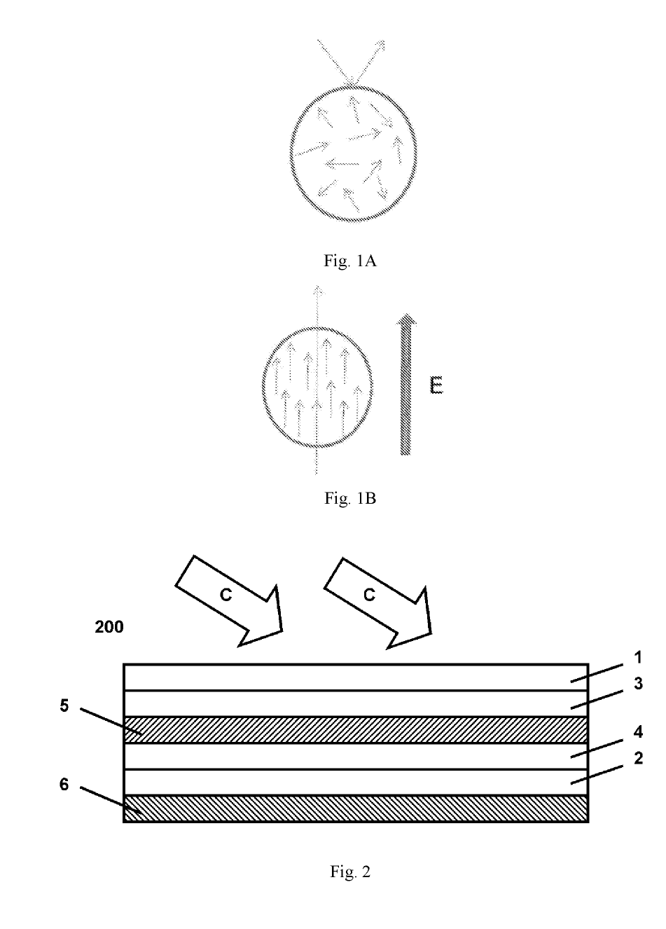

Referring to FIGS. 1A-1B, schematic distribution views of liquid crystal molecules in a PDLC layer of a PDLC display panel according to an embodiment of the present disclosure when no voltage is applied and when a voltage is applied are shown respectively. In FIGS. 1A-1B, an inverse PDLC layer is adopted. I.e., it exhibits a light scattering state when no voltage is applied (see FIG. 1A) and a transparent state when a voltage is applied (see FIG. 1B). Obviously, as can be easily understood by a skilled person in the art, a forward PDLC layer can also be adopted upon specific applications. That is, it exhibits a light scattering state when a voltage is applied and a transparent state when no voltage is applied, which is opposite to the case of an inverse PDLC layer. No matter which way is taken, the PDLC layer can make transitions between a transparent state and a light scattering state.

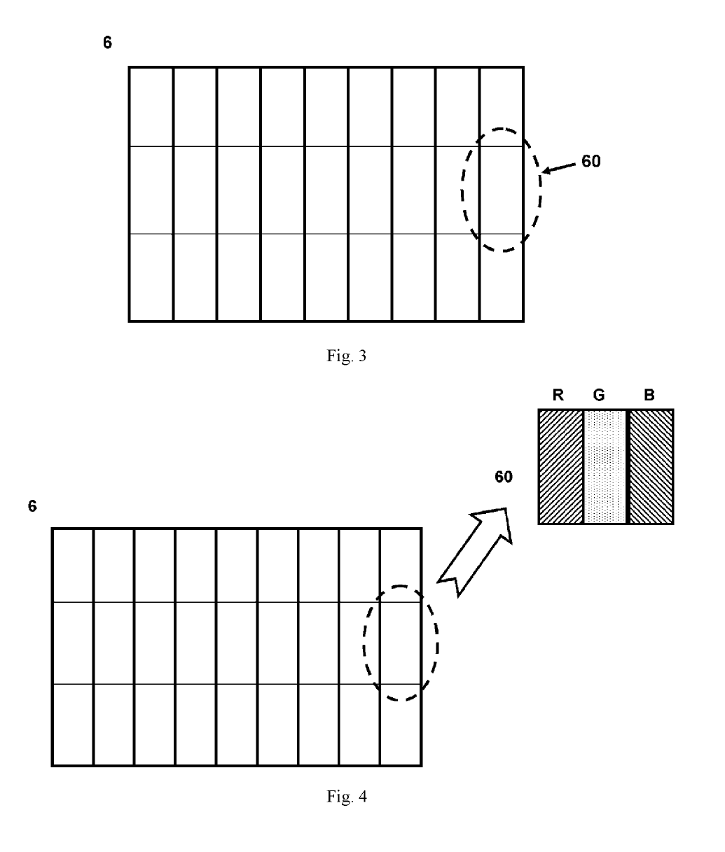

Further referring to FIG. 2, an exemplary section view of a PDLC display panel 200 according to an embodiment of the present disclosure is shown. The PDLC display panel 200 comprises: a first transparent substrate 1; a second transparent substrate 2 arranged opposite to the first transparent substrate 1; a first electrode layer 3 arranged on a side of the first transparent substrate 1 close to the second transparent substrate 2; a second electrode layer 4 arranged on a side of the second transparent substrate 2 close to the first transparent substrate 1, the second electrode layer 4 comprising a plurality of second sub-electrodes (not shown) arranged in an array; a PDLC layer 5 (indicated by a shadow of slashes in FIG. 2) arranged between the first electrode layer 3 and the second electrode layer 4; and a photochromic layer 6 (indicated by a shadow of backslashes in FIG. 2) arranged on a side of the second transparent substrate 2 remote from the PDLC layer 5. Besides, in FIG. 1, light incident on the PDLC display panel 200 is schematically indicated by two arrows C. In a specific implementation, the PDLC display panel 200 further comprises a plurality of pixel units defined by intersections of gate lines and data lines, each pixel unit comprising a second sub-electrode. For clarity, each pixel unit and a corresponding second sub-electrode are not specifically shown in the drawings, but for a skilled person in the art benefiting from the present disclosure, this should be obvious, and hence will not be illustrated specifically herein.

In such a PDLC display panel 200, a photochromic layer 6 is further arranged in addition to the PDLC layer 5 sandwiched between the first electrode layer 3 and the second electrode layer 4. Besides, external light C firstly passes through the PDLC layer 5, then enters the photochromic layer 6, and finally causes a photochromic reaction therein. In this case, both transparent display and various color display of different gray levels can be achieved. In addition, in the PDLC display panel 200 according to embodiments of the present disclosure, on one hand, only one PDLC layer is comprised, and on the other hand, no polarizers are required. As a result, the light loss (for example caused by absorption and the like) is greatly decreased, and the light utilization is improved, thus enhancing the display effect significantly.

In a specific implementation, the photochromic layer 6 can be made of one same material. In this case, the photochromic layer 6 is a homogeneous layer, which facilitates accurate control of different gray scales for various colors. Also, for the light source inducing the photochromic reaction, it can simply adopt a light source emitting monochromic light, which makes the structure of the entire display device even simpler.

Furthermore, referring to FIG. 3, a specific implementation of the photochromic layer 6 according to an embodiment of the present disclosure is described with more details. Specifically, FIG. 3 shows a top view of a photochromic layer 6 in a PDLC display panel 200 according to an embodiment of the present disclosure. In this case, the photochromic layer 6 comprises a plurality of regions 60, each region 60 corresponding to at least three adjacent pixel units in the plurality of pixel units, in particular to exactly three adjacent pixel units. Furthermore, referring to FIG. 4, in addition to the top view of the photochromic layer 6 in the PDLC display panel 200 according to an embodiment of the present disclosure, an enlarged top view of each region 60 in the photochromic layer 6 is also shown in FIG. 4. As can be seen from FIG. 4, each region 60 of the photochromic layer 6 can comprise a first sub-region, a second sub-region, and a third sub-region corresponding respectively to the corresponding three adjacent pixel units, i.e., a red sub-region R (schematically indicated by a shadow of slashes in FIG. 4), a green sub-region G (schematically indicated by a shadow of dots in FIG. 4), and a blue sub-region B (schematically indicated by a shadow of backslashes in FIG. 4). Specifically, a first material, a second material, and a third material comprised respectively in the three sub-regions R, G and B will turn red, green and blue respectively under a photochromic reaction. Although the three sub-regions R, G and B are juxtaposed vertically in FIG. 4, this is only a schematic representation, which does not represent any limitations to the present disclosure. Benefiting from the present disclosure, a skilled person in the art can easily conceive of other equivalent arrangements for the three sub-regions R, G and B.

Similar to the arrangement in a conventional RGB color film substrate, the photochromic layer 6 described with reference to FIGS. 3 and 4 comprises a plurality of regions 60, each region 60 comprising an R sub-region, a G sub-region and a B sub-region respectively. With such regions and RGB arrangement, the R, G and B sub-regions will emit red light, green light and blue light respectively, after a photochromic reaction. Color display of different gray levels in each region 60 of the photochromic layer 6 is achieved in further combination with the characteristic that different intensities of light induce the photochromic reaction.

As a further expansion, starting from the above arrangement of multiple regions 60 (wherein each region 60 comprises R, G and B sub-regions) in the photochromic layer 6, the patterned arrangement of the photochromic layer 6 can be designed more flexibly, so as to achieve personalized color display as defined by a user. Specifically, as desired by the user, the photochromic layer 6 can be configured to comprise a plurality of regions 60 in any shape (e.g., a circle, a square or the like), and the plurality of regions 60 can be arranged in any manner (e.g., in the form of an array, a star or the like). Based on that, the user can configure the photochromic layer 6 upon needs so as to achieve personalized color display as defined by the user.

In a specific implementation, the first material, the second material, and the third material in each region 60 of the photochromic layer 6 can be one selected from: a material of semiconductor oxides, a composite material of polyacids and semiconductors, and a composite material of heteropoly metal compounds and inorganic semiconductors. As a specific example, for the first material that turns red under a photochromic reaction, BaMgSi system from an inorganic system can be chosen, which can make transitions from white to red upon irradiation by UV light with a wavelength of 365 nm. Alternatively, fulgide photochromic compounds modified by spiroindoline groups with different substituents can also be chosen, which can achieve a color change from white to red upon irradiation by UV light. Besides, for the third material that turns blue under a photochromic reaction, N-methyl-5-carboxy-9′-hydroxyspiro oxazine can be chosen, which will make transitions from colorless to blue upon irradiation by UV light. Alternatively, N-methyl-3,3-dimethyl spiroindoline-naphthyloxazine can be chosen, which will make transitions from white to blue upon irradiation by UV light (e.g., with a wavelength of 365 nm). Additionally, the oxazine system as mentioned above can further achieve a transition from colorless to blue, purple and green after modification by spiroindoline groups with different substituents.

Obviously, as can be easily understood by a skilled person in the art, the present disclosure is not only limited to the specific materials as listed above.

Furthermore, the first electrode layer 3 and the second electrode layer 4 can comprise an indium tin oxide (ITO) electrode layer or an indium zinc oxide (IZO) electrode layer. Furthermore, the first transparent substrate 1 and the second transparent substrate 2 can comprise a transparent glass substrate or a transparent plastic substrate. Obviously, benefiting from teachings of the present disclosure, the skilled person can easily obtain other equivalent alternative materials, and the present disclosure is not limited to the specific materials listed above as examples in any way.

In a specific implementation, the first transparent substrate 1 and the second transparent substrate 2 can comprise a flexible film. Also, the first electrode layer 3 and the second electrode layer 4 can comprise a flexible conductive film. In this case, the PDLC layer 5 and the photochromic layer 6 as solid materials can be directly arranged on such a flexible film layer, thereby obtaining a flexible PDLC display device.

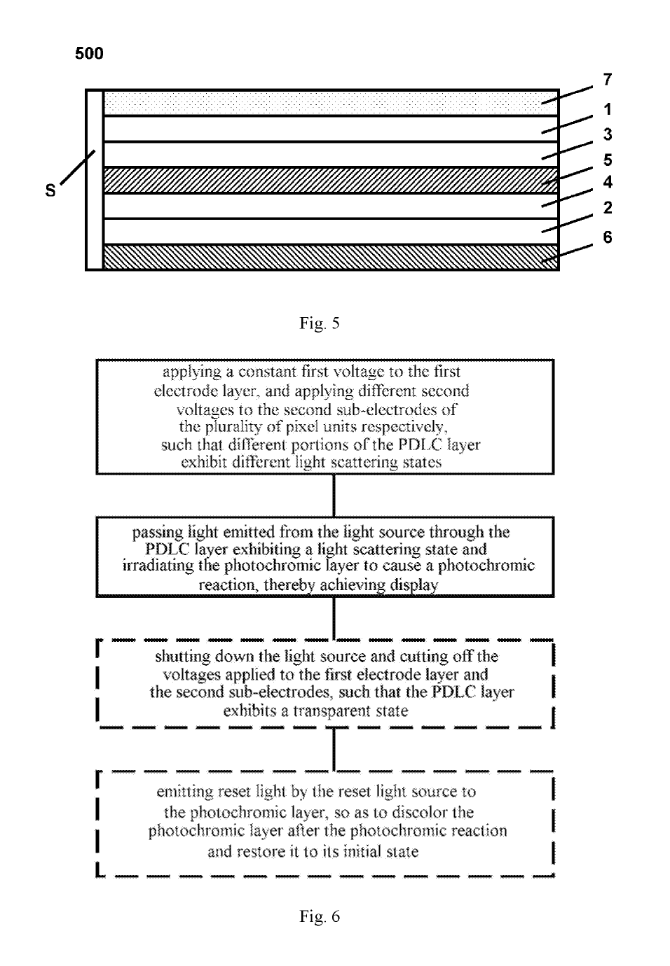

According to another aspect of the present disclosure, a PDLC display device is further provided. Specifically, referring to FIG. 5, a schematic section view of a PDLC display device 500 according to an embodiment of the present disclosure is shown. The PDLC display device 500 comprises: the PDLC display panel in any of the above embodiments; and a light source S, wherein light emitted from the light source S causes a photochromic reaction in the photochromic layer 6 after passing through the PDLC layer 5.

In a specific implementation, the PDLC display device 500 can further comprise: a light guide plate 7 (in particular, a transparent light guide plate) arranged on a side of the first transparent substrate 1 remote from the first electrode layer 3, and the light source S is arranged at a light incident side of the light guide plate 7, in particular on a side surface thereof. By arranging the light source S on a side surface of the display device 500 body, possible optical losses, such as occlusion and absorption caused by non-transparent light sources, are avoided. Thus, the light utilization of the entire display device is improved, and the transparent and color display effects are enhanced. Besides, in particular, by means of such a light guide plate 7, light emitted from the light source S can be transmitted through the PDLC layer 5 more conveniently, and then incident on the photochromic layer 6 afterwards.

In a specific implementation, the light source S is configured to emit light in a UV region or a visible region. Light emissions of different colors as required by the display can be obtained after the photochromic reaction by virtue of different photochromic responses of the photochromic layer 6 to UV light or visible light.

In a specific implementation, the PDLC display device 500 further comprises a reset light source configured to discolor the photochromic layer 6 after the photochromic reaction and restore it to its initial state. According to the above disclosure, the photochromic layer 6 will be subjected to a photochromic reaction when induced by corresponding light C, and thereby emit light of a color different from that in the initial state. Besides, the photochromic reaction of the photochromic layer 6 is caused by changes in the molecular structures. Therefore, after the photochromic reaction, even if light from the light source C is cut out, the photochromic layer 6 will maintain in a new state after the color change, instead of resuming the initial state before the color change. Based on that, stable display can be achieved. On the other hand, if other patterns or patterns of a next frame need to be displayed, it is only necessary to simply apply the reset light source to discolor the photochromic layer 6 and restore it to the initial state.

According to yet another aspect of the present disclosure, a method for driving the PDLC display device according to any of the above embodiments is further provided. Specifically, referring to FIG. 6, a schematic flow diagram of a method for driving a PDLC display device according to an embodiment of the present disclosure is shown. The driving method can comprise: applying a constant first voltage to the first electrode layer, and applying different second voltages to the second sub-electrodes of the plurality of pixel units respectively, such that different portions of the PDLC layer exhibit different light scattering states; and passing light emitted from the light source through the PDLC layer exhibiting a light scattering state and irradiating the photochromic layer to cause a photochromic reaction, thereby achieving display. Since each second sub-electrode has a different voltage, the light scattering states exhibited by the PDLC are different, i.e., the amounts of light transmitted thereby are different. Thus, the amounts of light irradiating the photochromic layer are different. In this way, color display of different gray levels can be achieved. Furthermore, the driving method can further comprise: shutting down the light source and cutting off the voltages applied to the first electrode layer and the second sub-electrodes, such that the PDLC layer exhibits a transparent state. Still furthermore, the driving method can further comprise: emitting reset light by the reset light source to the photochromic layer, so as to discolor the photochromic layer after the photochromic reaction and restore it to its initial state. With such a driving method, patterning of the PDLC layer and also normal display of the PDLC display device are achieved. Besides, after driving, even if the PDLC display device is non-energized, it can still continuously display patterns, thus facilitating achievement of stable display effects. Moreover, the PDLC display device can be prepared for displaying other images or images of a next frame simply upon irradiation by the reset light.

As can be seen, according to embodiments of the present disclosure, the PDLC display panel and the PDLC display device are not only helpful in achieving transparent and color display of higher efficiency and higher quality, but also compatible with any existing TFT-LCF process due to their simple structures. Moreover, such a PDLC display panel and PDLC display device can be designed as flexible products for achieving flexible transparent display. Furthermore, stable display and easy substitutability of the photochromic layer are also taken into consideration, and implementations of more flexible and more energy-saving PDLC display panel and PDLC display device are facilitated.

It should be pointed out that directional or positional relations indicated by terms such as “center”, “up”, “down”, “front”, “back”, “left”, “right”, “vertical”, “horizontal”, “top”, “bottom”, “interior” and “exterior” are directional or positional relations shown on the basis of the drawings. They are used only for describing the present disclosure; instead of indicating or implying that the indicated devices or elements must be orientated specifically, or constructed and operated in a specific orientation. Thus, they cannot be construed as limiting the present disclosure.

Terms such as “first” and “second” are used only for descriptive purposes, and should not be construed as indicating or implying relative importance or hinting the number of the indicated technical feature. Therefore, features defined by terms such as “first” and “second” may indicate explicitly or implicitly that one or more such features are comprised. In the description of the present disclosure, “multiple” means two or more, unless otherwise explained.

In depictions of the present description, specific features, structures, materials or characteristics disclosed therein can be combined in any suitable manner in any one or more embodiments or examples.

Although specific embodiments of the present disclosure have been shown and described, it is obvious for a skilled person in the art to make modifications and changes without departing from a broad scope of the present disclosure. And, the appended claims are intended to cover all such modifications and changes falling within the true spirit and scope of the present disclosure.

1. A PDLC display panel, comprising:
a first transparent substrate;
a second transparent substrate arranged opposite to the first transparent substrate;
a first electrode layer arranged on a side of the first transparent substrate close to the second transparent substrate;
a second electrode layer arranged on a side of the second transparent substrate close to the first transparent substrate, the second electrode layer comprising a plurality of second sub-electrodes arranged in an array;
a PDLC layer arranged between the first electrode layer and the second electrode layer; and
a photochromic layer arranged on a side of the second transparent substrate remote from the PDLC layer for achieving color display.

2. The PDLC display panel according to claim 1, further comprising: a plurality of pixel units defined by intersections of gate lines and data lines, each pixel unit comprising one of the second sub-electrodes.

3. The PDLC display panel according to claim 2, wherein
the photochromic layer comprises a plurality of regions, each region corresponding to at least three adjacent pixel units in the plurality of pixel units.

4. The PDLC display panel according to claim 3, wherein
each region of the photochromic layer corresponds to three adjacent pixel units in the plurality of pixel units, and
each region of the photochromic layer comprises a first sub-region, a second sub-region and a third sub-region corresponding respectively to the corresponding three adjacent pixel units.

5. The PDLC display panel according to claim 4, wherein
the first sub-region comprises a first material that turns red under a photochromic reaction,
the second sub-region comprises a second material that turns green under a photochromic reaction, and
the third sub-region comprises a third material that turns blue under a photochromic reaction.

6. The PDLC display panel according to claim 5, wherein
the first material, the second material and the third material comprise respectively one selected from: a material of semiconductor oxides, a composite material of polyacids and semiconductors, and a composite material of heteropoly metal compounds and inorganic semiconductors.

7. A PDLC display device, comprising:
the PDLC display panel according to claim 1; and
a light source.

8. The PDLC display device according to claim 7, wherein
the PDLC display device further comprises: a light guide plate arranged on a side of the first transparent substrate remote from the first electrode layer, and
the light source is arranged at a light incident side of the light guide plate.

9. The PDLC display device according to claim 7, wherein
the light source is configured to emit light in a UV region or a visible region.

10. The PDLC display device according to claim 7, wherein
the PDLC display device further comprises: a reset light source configured to discolor the photochromic layer after the photochromic reaction and restore it to its initial state.

11. The PDLC display device according to claim 8, wherein
the light source is configured to emit light in a UV region or a visible region.

12. The PDLC display device according to claim 8, wherein
the PDLC display device further comprises: a reset light source configured to discolor the photochromic layer after the photochromic reaction and restore it to its initial state.

13. The PDLC display device according to claim 9, wherein
the PDLC display device further comprises: a reset light source configured to discolor the photochromic layer after the photochromic reaction and restore it to its initial state.

14. The PDLC display device according to claim 11, wherein
the PDLC display device further comprises: a reset light source configured to discolor the photochromic layer after the photochromic reaction and restore it to its initial state.
